(19) United States
(12) Patent Application Publication
(10) Pub. No.: US 2013/0110738 A1
(43) Pub. Date: May 2, 2013

(54) POLITICAL DONATION ALLOCATION SYSTEM AND METHOD

(71) Applicants: William H. McHorris, Chicago, IL (US); Todd W. Stump, Chicago, IL (US); Ken Ratliff, Richmond, VA (US)

(72) Inventors: William H. McHorris, Chicago, IL (US); Todd W. Stump, Chicago, IL (US); Ken Ratliff, Richmond, VA (US)

(21) Appl. No.: 13/661,765

(22) Filed: Oct. 26, 2012

Related U.S. Application Data
(60) Provisional application No. 61/551,568, filed on Oct. 26, 2011.

(51) Int. Cl. G06Q 99/00

(52) U.S. Cl. 705/329

(57) ABSTRACT

A method is described for providing efficient contribution allocation recommendations to contributors providing contributions to political candidates. The method includes: receiving, by a contribution allocation system, inputs from a contributor indicating the contributor's position with respect to a plurality of issues; quantitatively comparing the contributor's positions with respect to the plurality of issues to a plurality of candidates' positions with respect to the plurality of issues; assigning a score to each of a plurality of candidates based on their compatibility with respect to the compared issues and further based on election-related parameters; and providing a recommended contribution allocation for the contributor based on the scores assigned to the plurality of candidates.

### CROSS-REFERENCE TO RELATED APPLICATIONS

This patent application claims the benefit of U.S. Provisional Patent Application No. 61/551,568, filed Oct. 26, 2011, which is incorporated herein by reference in its entirety.

### FIELD

The present invention relates generally to a computer-implemented system and method for efficient resource allocation, and more specifically for allocating contributions to candidates for political office.

### BACKGROUND

The election of United States political candidates for public office has become a multi-billion dollar industry. As part of the election process, candidates often solicit large amounts of donations from contributors to fund their political campaigns.

Individuals and other entities make contributions to candidates with the proximate purpose of electing them to office and for the ultimate purpose of advancing public policy goals, yet those contributions are typically not made in such a way as to maximize return on investment, i.e., to efficiently advance those policy goals. As a result, a great deal of money is not invested at all or is contributed in a way that has little effect on the preferred outcome. Resources frequently do not find their way to the opportunities where they can make the most difference.

Inefficiencies in the traditional contribution process include, but are not limited to, contributions to candidates who: are substantially certain to win; are substantially certain to lose; hold diverging policy preferences from the investor; are in races that, regardless of outcome, are unlikely to make a difference in policy outcome; are in races that are already saturated with resources; or are in races in which they have narrow differences on a desired policy outcome as compared to their opponents.

Evidence suggests that a contributor is most likely to invest in a candidate in his own district, which often is not the most efficient use of his resources. He may, for example, support a Republican candidate in his district, but if this district typically votes 65% Republican and 35% Democrat (or vice-versa), an investment in this race will have nearly zero effect.

On the other side, candidates—who require financial resources in order to communicate and compete—are currently raising funds from contributors with sub-optimal efficiency. These inefficiencncies include, but are not limited to: spending money to independently develop and exploit proprietary databases; overloading shared databases by sending duplicative communication (asking the same audiences for the same thing as other candidates); spending money to communicate with people unlikely to contribute; and spending money on expensive modes of communications such as direct mail.

For example, a candidate for office may solicit funds from the entire set of his party's voters within his district, but the likely will not know which among them are proven contributors. He may also purchase and exploit databases of known contributors that have also been purchased and exploited by other candidates.

In the political realm, the value of a single ballot box vote is considered to be constant. While this may be true in theory, the proposition has limitations in practice. For example, a vote in excess of victory is typically worth less than a vote required to attain victory.

The cost to obtain a vote also is not constant. Certain voters are easy to reach at a low cost, while other voters are difficult to reach at a high cost. Similarly, certain voters need less motivation while others need more. Advertising cost, population density, competitiveness and other factors also affect the cost to obtain a vote.

The value of a vote within a legislative body is also considered to have a constant value. When a bill is considered for passage in the United States House of Representatives, a vote by the Representative from the 8^{th} District of Indiana, for example, is generally equal to a vote by the Representative from the 24^{th} District of California. But this proposition can also vary. For example, the vote of a legislator on a key committee or by a member with more seniority may have more marginal value than the vote of a freshman legislator. Also, if a legislator is among a group constituting a small minority in favor of a preferred policy, his vote may have less marginal value. Other considerations also affect the value of a legislative vote.

The inventors have created the above body of background information for the convenience of the reader; the foregoing is not an attempt to review or catalog the prior art.

### SUMMARY

Embodiments of the present invention provide a system and method for making the most efficient use of contributor resources to connect potential contributors with candidates that are most likely to advance the contributor's preferred policy goals through specific recommendations of the proportions by which the contributor should allocate his financial resources among such candidates. Further, embodiments of the present invention enable candidates to raise more funds from more contributors while minimizing the cost to do so.

In an embodiment, the present invention provides a method for making efficient contribution allocation recommendations to contributors providing contributions to political candidates. The method includes: receiving, by a contribution allocation system, inputs from a contributor indicating the contributor's position with respect to a plurality of issues; quantitatively comparing the contributor's positions with respect to the plurality of issues to a plurality of candidates' positions with respect to the plurality of issues; assigning a score to each of a plurality of candidates based on their compatibility with respect to the compared issues and further based on election-related parameters; and providing a recommended contribution allocation for the contributor based on the scores assigned to the plurality of candidates.

In a further embodiment, the method is implemented as computer-executable instructions stored on a non-transitory computer-readable medium.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram of an exemplary operating environment usable in embodiments of the described principles;

FIG. 2 is a flowchart generally illustrating a general process for providing a recommended contribution allocation to a contributor;

FIG. 3 is a diagram illustrating components of an exemplary screen that may used to present a recommended contribution allocation to a contributor.

### DETAILED DESCRIPTION

Before discussing the details of the invention and the environment wherein the invention may be used, a brief overview is given to guide the reader. In general terms, not intended to limit the claims, embodiments of the invention provide a system and method for dramatically improving the efficiency of political contributions and/or political fundraising. Contributors may be alerted to candidates that may benefit most from the contributor's funds and are most likely to advance the contributors' policy preferences, while candidates similarly may be directed to contributors likely to contribute to their campaigns. Contributors receive allocation recommendations indicating how much of their investment resources should be contributed to which candidates, and candidates receive targeted access to potential contributors.

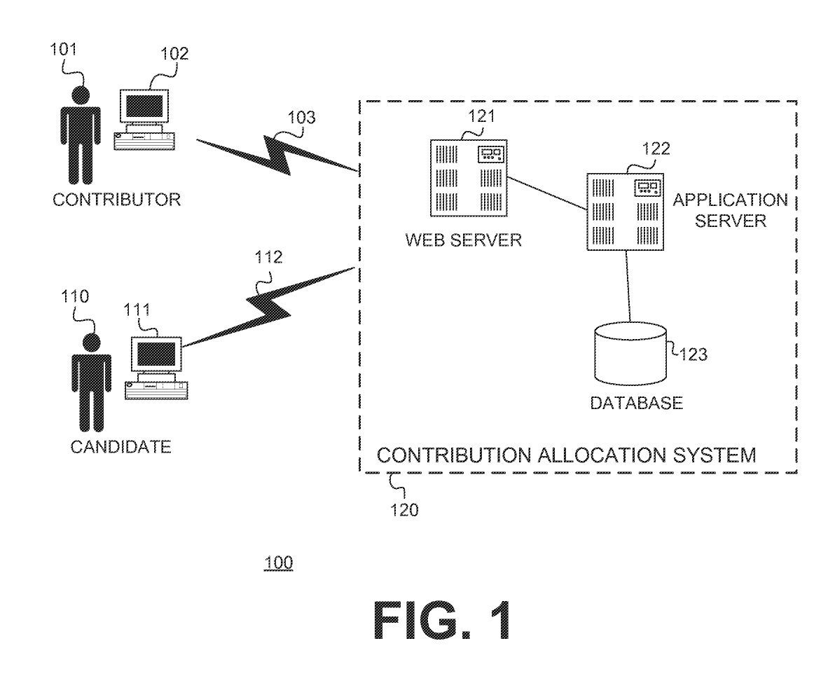

Given this overview, an exemplary environment in which the invention may operate is described hereinafter. It will be appreciated that the described environment is an example, and the components depicted do not necessarily imply any limitation regarding the use of other environments to practice the invention. With reference to the diagram 100 of FIG. 1, there is shown an example of a contribution allocation system 120 that is used in an exemplary embodiment by contributors and candidates, which are represented by contributor 101 and candidate 110, through their respective computing devices, as represented by computing devices 102 and 111. The contribution allocation system 120 is preferably implemented via a networked system accessible over the Internet that is accessible to the contributor 101 and the candidate 110 via network connections 103 and 112.

The computing devices 102 and 111 may, for example, be personal computers, laptops, cell phones, PDAs, tablet computers, or any other type of device capable of accessing the network and suitable for performing the appropriate processing. A graphical user interface may be presented through a browser or other applications executing on the computing devices 102 and 111, based on information communicated by a web server 121 of the networked contribution allocation system 120. In the exemplary architecture depicted in FIG. 1, an application server 122 carries out functionality associated with the contribution allocation system 120, including backend processing that is not necessarily seen through the graphical user interface. A database 123 stores information used by the contribution allocation system 120.

Although the terms “web server,” “application server,” and “database” are used herein in describing the illustrative system shown in FIG. 1, it will be appreciated that other system configurations—e.g., LAN, WAN, cloud-computing, configurations using multiple sets of servers, etc.—using a variety of hardware suitable for web applications are usable in alternative implementations of the inventive principles described herein.

Data transmission to and from the contribution allocation system 120, e.g. through network connections 103 and 112 and through other network connections with other entities not depicted in FIG. 1, may be conducted through a secure connection such as HTTPS and/or be encrypted with protocols such as SSL or TLS or other public key encryptions. The data may be handled using a content management system (CMS) and a content management framework (CMF) such as, but not necessarily, DRUPAL, Linux, or Microsoft's open-source platform. The CMS and CMF also may allow the contribution allocation system 120 to link to one or more existing social networks for further sharing and distribution of data. In further embodiments, the contribution allocation system 120 may employ a content delivery or distribution network to improve system response, particularly if a large number of users seek to use the system.

Although not depicted in FIG. 1, it will further be appreciated that system administrators may access the contribution allocation system 120 through computing devices that are part of the contribution allocation system 120 or connected to the contribution allocation system 120 via a local network or the Internet. Third parties such as political organizations and outside vendors may also access the contribution allocation system 120 through computing devices connected via the Internet. Additionally, the contribution allocation system 120 may connect to various external sources (such as RSS and XML feeds, public and proprietary databases, etc.) via an Internet connection.

It will further be appreciated by those of skill in the art that the execution of the various computer-implemented processes and steps described herein occurs via the computerized execution of computer-executable instructions stored on one or more tangible, non-transient computer-readable media, e.g., RAM, ROM, PROM, volatile, nonvolatile, or other electronic memory mechanism. Thus, for example, the operations performed by the computing devices 102 and 111 and by the components of the contribution allocation system 120 are carried out according to instructions executed by one or more processors of the computing devices and the contribution allocation system.

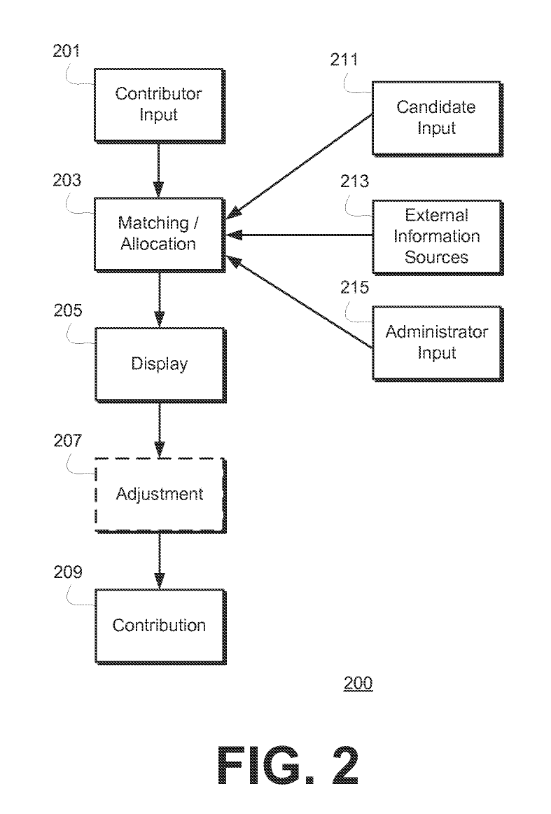

With further reference to the architecture of FIG. 1, and turning more specifically to FIG. 2, an exemplary process 200 is depicted for providing a contributor with a recommended contribution allocation for candidates that match the contributor's preferences. At stage 201, a contributor provides input regarding the contributor's positions with respect to various issues to a contribution allocation system, for example, by using a computing device 102 to access a website maintained by the contribution allocation system 120 and providing information through the website's user interface.

In a further exemplary embodiment, potential contributors that access the contribution allocation system 120 are prompted by the contribution allocation system 120 to register and create a profile, which is stored at database 123. Each profile may include information such as age, gender, location, party registration, etc. Once a contributor's profile has been created, the contribution allocation system further prompts the contributor to provide information as to the contributor's positions with respect to various issues, which will be used for matching the contributor with appropriate candidates and determining a recommended contribution allocation tailored based on the contributor's preferences. It will be appreciated that for each of the issues that a contributor is prompted to provide feedback on, the system may further present the contributor with prompts regarding one or more sub-issues relating to the issue.

It will be appreciated that a variety of types of prompts may be used to elicit a variety of types of responses. Some prompts (e.g., “Do you believe the Constitution guarantees the individual the right to own a firearm?”) may be best suited to an either/or, yes/no, or 1/0 binary-type response. Other prompts may be better suited to responses that exist within a range and may require that the system prompt the contributor to place his preference along a continuum. This may be achieved by presenting the contributor with one or more generally continually incrementally adjustable inputs for each issue, such as, for example, a sliding scale from 1 to 10 where 1 indicates “strong disagreement” and 10 indicates “strong agreement.” Other prompts may be better suited to a multiple choice response in which the contributor will choose from a list of pre-determined answers. Other prompts may be better suited to responses that prompt the contributor to rank choices from most desirable to least or vice-versa. Other prompts may be better suited to responses that are not described herein, but that may be determined based on contributor behavior.

For each issue for which the contributor has expressed a position, the contribution allocation system may further prompt the contributor to indicate the importance of the issue to the contributor. For example, this may be achieved by presenting the contributor with one or more generally continually incrementally adjustable inputs for each issue, such as by providing a adjustable slider bar using which the contributor can indicate that the issue corresponding to the prompt is very important (or not important) to the contributor. In a further embodiment, the contributor may be given the option to expressly indicate that a certain issue is a “disqualifier” issue where, if a candidate disagrees with the contributor's position on that issue, the contributor does not wish to contribute to that candidate. When the contribution system seeks to match the contributor with candidates, the contribution system will filter out candidates based on the disqualifier issue and will not provide a recommended contribution allocation that recommends contributions to candidates that conflict with the contributor on the disqualifier issue.

In an exemplary embodiment, the system may present the contributor with a predetermined group of prompts, corresponding to a variety of issues, for the contributor to respond to. In another embodiment, the system may present the contributor with categories of issues and allow the contributor to select which issues for which the contributor wishes to answer prompts. In a further embodiment, the presentation of groups of prompts to a contributor may be presented in various stages or groupings, so that the contributor is not overwhelmed with a large number of prompts at the outset, and the contributor is provided with the option to answer more prompts if he or she wishes. Although a contributor may enter as little or as much information as he or she desires. more information generally leads to more accurate analysis and better customized allocation recommendations.

By analyzing the contributor's responses to various prompts, the contribution allocation system builds and stores an Issue Profile for the contributor, which records the contributor's positions and preferences regarding various issues, and is used to determine whether the contributor will be compatible with various candidates. Further, by analyzing the Issue Profiles of multiple contributors in the aggregate, the contribution allocation system is able to determine overall attitudes about public policy among contributors, e.g., by identifying contributors' positions and the importance of various issues to the contributors' in the aggregate. The contribution allocation system may also identify trends in the contributors' positions, for example, shifts in the importance of certain issues.

The prompts that are provided to contributors may be stored in a searchable database or list, which may be updated over time to account for new issues influenced by current events or by contributor behavior indicating changes in interest. For example, in one election cycle, health care reform may be a dominant issue, whereas the importance of job creation may be dominant in another election. The system may rely on external sources of information in addition or alternatively to contributor-input information, e.g., news sources, discussion boards, Internet-based trending topics (such as words or phrases searched most frequently using one or more search engines or discussed in social media and including searchable metadata such as hash tags), pending legislation discussions, etc., to determine what issues may appear most relevant in order to update and/or optimize the list of issues presented to the contributor. Data from many of these sources may be digitized in a form that allows for searching, importation, and analysis, e.g., XML. The database 123 may include storage of keywords against which the source data may be analyzed. The system also may parse data sources and determine what words or phrases appear in multiple sources. These words or phrases may be compared against database objects to determine whether there are any shared attributes or whether the phrases are in the same domain as an existing issue, e.g., the word “Medicare” appearing in a plurality of source may indicate that “Health Care” is a prominent issue for which analysis and matching may be desired.

After the contribution allocation system receives contributor input as to the contributor's positions (at stage 201), the contribution allocation system searches for candidates that match with the contributor's positions at stage 203. Candidate information used in the matching process may be input into the contribution allocation system by the candidates themselves (as represented by stage 211). Similar to the process used to create profiles for the contributors, the contribution allocation system may prompt candidates to register and create candidate profiles, as well as respond to prompts regarding their positions on various issues and the policies they plan to implement if elected. These prompts may be the same or different from the prompts used for the contributors. Also, candidate profiles may include background information such as name, party, incumbent/challenger, office running for, etc.

In one embodiment, the contribution allocation system may require each candidate to provide input with respect to substantially all issues, so that the system may be able to correlate each contributor's preferences to each candidate, regardless of what issues the contributor may or may not address. The system may penalize candidates who provide fewer responses to the set of issue prompts in one or more ways. First, with a lack of responses, fewer potential contributor matches may be found that align sufficiently with the candidate. Second, with respect to the matching processes described below, the system may include a step in which the candidates' compatibility scores are reduced by a predetermined amount, percentage, etc., for each unanswered issue. In another embodiment, the contribution allocation system requests as much data entry from candidates as possible, but it is not required. In situations where it is not possible to determine whether a contributor and candidate will be compatible with respect to an issue because the candidate has not entered a position, the system can ignore that issue when matching (or interpret the lack of a position as a conflict with the contributor) and/or notify contributors that the candidate has not indicated a position on that issue.

Information regarding the candidates and their positions used in the matching and allocation analysis process may also come from external sources (as represented by stage 213). For example, information can be gathered through automated data collection from one or more data repositories. These data repositories may be databases of publicly available information or permission-based sources and may be accessed via, for example, automatic RSS/XML feeds or manual periodic downloading of data. In another example, the contribution allocation system may utilize political organizations or outside vendors to input information into the system regarding candidates (and/or contributors).

In a further embodiment, information relating to candidates may also be entered into the contribution allocation system by a system administrator (as represented by stage 215). For example, system administrators of the contribution allocation system may perform research as to candidates' positions and preferences (e.g. by attending political events, conducting interviews, gathering articles and publications, etc.), and enter those into the contribution allocation system through a system administrator user interface.

If information obtained from an external source or entered by a system administrator conflicts with information entered by a candidate, the contribution allocation system may give preference to one or the other for the purposes of matching, and/or indicate to the candidates and/or contributors that such a conflict exists in an appropriate manner (e.g. when a contributor is viewing matching results or through a notification message to a candidate). In one example, the system obtains objective data from a plurality of sources—for example, for incumbent candidates, the system may analyze third-party sources including voting records and cross-check them against candidate-entered responses. Using this objective data, the system may detect and announce discrepancies between what a candidate claims and what his voting history indicates. Other data sources may include fundraising reports, the number, location, and content of media buys, and reports or speeches to various groups including, e.g., political action committees.

It will be appreciated that, in a further embodiment, candidates who have not registered for the contribution allocation system may nonetheless be included in the matching process if data regarding those candidates is collected through external sources or entered by a system administrator. It will also be appreciated that data collection from external sources and through entry by a system administrator may also be used to supplement contributor records as well. For example, voting records from public databases may be collected by the contribution allocation system, and that information can be stored with the corresponding contributor records.

Thus, the matching process at stage 203 uses a combination of contributor-input information and candidate information input by the candidate, collected from external sources, and/or input by a system administrator, so as to determine a level of compatibility in the form of a score for each candidate. One skilled in the art will appreciate that a variety of different algorithms could be used to assess compatibility based on contributor and candidate information.

In one example, the contribution allocation system starts with a baseline number of points that represents a generally ideal correlation. This baseline number may correspond to substantially identical responses for each contributor-entered issue. Once this baseline number is determined, it may be adjusted by one or more factors. The baseline number may be reduced by predetermined amounts for deviations between contributor preferences and candidate preferences. For instance, for subjective inputs, if both preference and intensity are measured on a scale of 0 to 100, each point of deviation between the contributor and candidate values may be a point deducted from the baseline number. Conversely, for more objective inputs such as party affiliation, deviation between contributor and candidate responses may result in a larger predetermined deviation from the baseline. In another example, the contribution allocation system may start with a baseline compatibility score of zero, and add or subtract to it based on the similarities and differences of the contributors' and candidates' positions.

In another example, issues that call for a subjective response may be seen as a matrix of preference and intensity values. Either the contributor's or the candidate's response for an issue may be seen as the target on the matrix with a plurality of zones radiating outward, each zone representing a larger deviation from the baseline. The zone in which the candidate's response falls may translate to the deviation, or vice-versa.

In still another example, quantitative representations of contributors' and candidates' responses to prompts are compared by producing a relationship figure (i.e., a numerical mapping) between a contributor's positions and the candidates' positions. These relationship figures are then ranked by the system to determine an order of candidates that are compatible with a contributor from most compatible to least compatible.

In still another example, the system may provide the contributor with the ability to designate one or more issues as “disqualifiers” as mentioned above. Disqualifier issues may be expressly designated by the contributor or may be automatically designated by the system, e.g., where a candidate's deviation is larger than a predetermined amount. For instance, the deviation may relate to objective issues such as party affiliation, such that an opposite answer automatically may disqualify the candidate. In other instances, the deviation may relate to subjective answers such as to a preference component of the issue, e.g., a candidate that expresses any preference in favor of increasing a debt limit—even if it is only a 51% preference—may be disqualified if the contributor is opposed to increases and selects that issue as a disqualifier. In still other instances, disqualification may require at least a minimum spread between the contributor's and candidate's preference values.

The system may analyze all issues for which both the contributor and candidate have provided responses. Alternatively, the system may prompt the contributor to identify one or more issues to which the contributor may want to restrict analysis, e.g., the contributor may have provided information regarding a dozen or more issues, spanning social, economic, diplomatic, etc., topics but may wish solely to find candidates with shared economic views. For example, by selecting the economic issues, the system may filter the comparative variables to exclude social, diplomatic, etc., issues. The system may enable the contributor to select the issues for inclusion or exclusion. Additionally or alternatively, each issue may include one or more metatags describing its subject matter, and the system may prompt the contributor to focus the evaluation by selecting one or more metatags from a list.

The more issues for which both the contributor and candidate provide answers, the more robust the analysis may be. Therefore the system may modify the baseline value to account accordingly, e.g., the baseline may be modified downward more significantly when fewer issues are analyzed and less significantly when more issues are reviewed.

While a compatibility rating between a contributor and various candidates is useful information for a contributor, compatibility values do not provide a contributor with a complete optimization of how to allocate contributions between various candidates. An analysis of a recommended contribution allocation by the contribution allocation system according to embodiments of the present invention at stage 203 may take into account one or more of numerous election-related parameters, including but limited to:
General Compatibility—The system may add to or increase the candidate score of a candidate that is running against an opponent with whom the contributor is incompatible. Similarly, the system may subtract from or decrease the candidate score of a candidate that is running against an opponent that is also compatible with the contributor.
Likelihood of Success—The closer the race, i.e., the narrower the spread (the difference between the candidates share of the future vote according to polling data or other source data), the greater the value of each additional vote; the wider the spread, the lesser the value of each additional vote. This principle is true regardless of which side of the proposition the contributor sits, i.e., whether his more closely-aligned candidate is in the lead or trails. Close races, i.e., those with a high degree of uncertainty, e.g., with narrower spreads, changing voter demographics, higher than average voter intensity, etc., may be referred to as “high gamma” races. These “high gamma” races may be in distant geographic locations and may feature less well-known candidates than in other races, such that it is likely the contributor may not be aware of the race, the candidates, or how closely aligned he may be to one of the candidates. Without the system, the contributor is likely to allocate funds to a race, his local race for example, that may result in the failure of his desired outcome. Candidates that are in close races, e.g., within a predetermined percentage of an opponent or within a predetermined percentage of the predicted number of votes needed for a victory, may have their baseline number adjusted. The degree of adjustment may depend on the closeness of the race, e.g., a candidate having a 2% lead or deficit may have his baseline adjusted more favorably than a candidate having a 3% lead or deficit and even more favorably than a candidate having a 15% lead or deficit.
Secondary Success—A victorious candidate may be so outnumbered in his legislative body that he has no hope of success in advancing policy. The value of a vote in this contest may be less than the value of a vote in a lower gamma contest that decides the majority of a legislative body. A candidate running for office in an election where a change in majority support of a given issue or change in majority control by a party within a governing body may have his baseline number similarly adjusted, i.e., if the candidate's election can change what party has a majority or make it more likely that the party will retake control of a governing body or maintain a slight majority, and if the candidate otherwise is favorably related to the contributor, that candidate's baseline number may be adjusted to make him a more favorable recipient. Conversely, if the candidate is not otherwise compatible to the contributor, the candidate's baseline number may be adjusted to make him a less favorable recipient, which may reduce the possibility that the contributor donates to a candidate whose election may result in negative consequences for the contributor.
Margin of Victory—In most races, a plurality of the vote equals victory. Therefore, any single vote in excess of plurality may have less value than the ones before it, although at some point an anticipated vote total may be sufficiently low enough that the system considers victory unlikely, thereby reducing the relative value of additional votes. In both of these cases, votes still may have value, albeit a diminished value.
Displacement—Districts or states where the nominee of one party is consistently elected by a large number of votes in excess of majority may discourage competition from challengers, thereby freeing resources for higher gamma races.
Candidate Status—Committee chairs and incumbents with seniority may be deemed to have more value in the legislative process than junior members of the legislative body. Thus, these candidates' rankings may be positively augmented. Similarly, if the candidate's preferences align more with these candidates' opponents, those opponents' rankings may be augmented positively in an attempt to unseat an influential incumbent.
Saturation—Higher profile races generally attract more money, potentially reducing the impact that the donor's contribution may have. A better potential return for the contributor may be achieved through investment in a candidate in a lower profile race.
Gamma Value for Each Contest—Using a number of influences—including but not limited to poll results, incumbency, committee rank, fundraising, and cost of campaigning—the system calculates a “gamma” value for each contest, and the contests receive a gamma weighting via a logistic pdf (i.e., a smooth function that allows a linear combination of race factors to be applied to the function and resulting values are expressed as probability of a race win).
Quantity of High Gamma Contests—The smaller the pool of high gamma races, the higher the value of a vote in a high-gamma race may be.
   It will be appreciated that other parameters in place of, or in addition to, the parameters listed above may be applied as part of the system.

In one embodiment. the contribution allocation system begins with a compatibility rating between a contributor and a candidate based on their positions on various issues (as previously described above), and then adjusts that compatibility rating up or down based on the various parameters described in the preceding paragraph (e.g., by multiplying the candidate's compatibility rating with a gamma value associated with that candidate's race). However, it will be appreciated that various analytical methods can be used for determining a degree of fit between a contributor and one or more candidates based on their positions on issues and the other general election parameters described above. In one example, the determination of a compatibility rating begins with a baseline score, with candidate/contributor responses that are deemed similar including an increasing multiplier to increase the candidate score, whereas dissimilar responses may result in a decreasing (e.g., fractional) multiplier being applied to the score, and with the various election parameters described above causing further adjustment of the score (e.g., a compatible candidate in a tight race receives an upward score adjustment). Alternatively, candidate score adjustment may be additive for one or more variables, as opposed to multiplicative modifications. As still another option, candidate score adjustment may include combinations of additive and multiplicative adjustments.

Based on the foregoing analysis performed by the contribution allocation system, a recommend contribution allocation—that recommends how much of the contributor's capital should be allocated to one or more candidates—is generated and displayed to the contributor on the contributor's computing device at stage 205. In one embodiment, these allocations may be expressed as percentage allocations between a number of candidates having the highest candidate scores. The contribution allocation system may use a predetermined number of candidates or may allow the contributor to specify among how many candidates his or her contributions are to be divided. Alternatively, a predetermined or contributor-defined compatibility threshold may be established such that all candidates at or above that threshold level of compatibility may be displayed, while candidates below the threshold may be omitted. Additionally, the system may calculate and present the contributor with a cash reserve component, i.e., an amount of funds that the system suggests may be held back and not contributed at that time in order to preserve the opportunity to make future contributions closer to the election or to see how the race unfolds to determine whether a future contribution is sufficiently worthwhile.

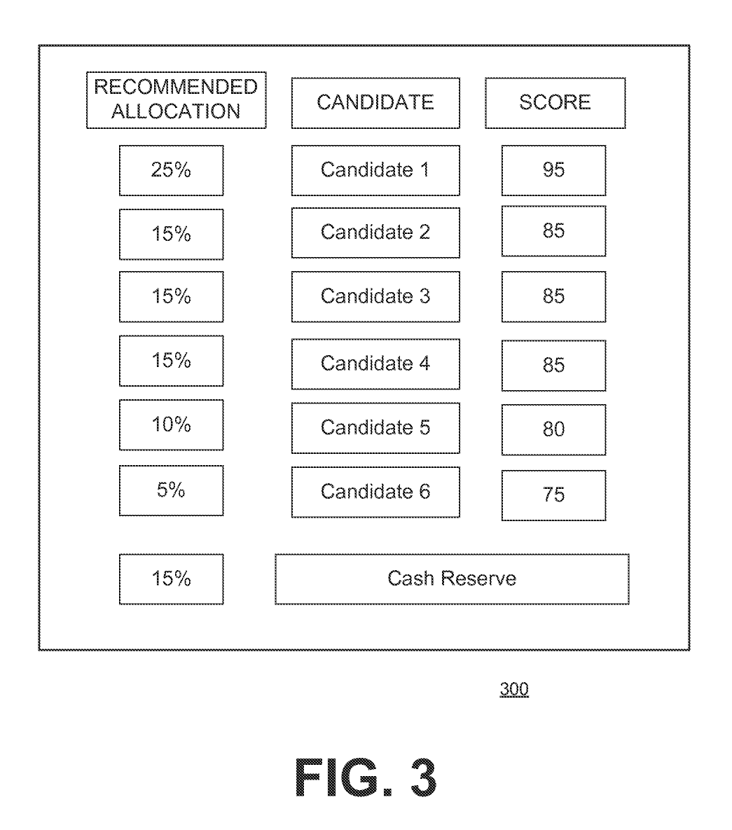

An example is provided by FIG. 3, which is a diagram 300 of the components of an exemplary screen that may be presented to a contributor after the matching/analysis of candidates for that contributor has been performed by the contribution allocation system. The screen includes a listing of the top six candidates in descending order according to score (the six candidates having the highest candidate scores), and a normalized distribution of recommended allocations as a percentage corresponding to each of those candidates and a percentage corresponding to a cash reserve. In one embodiment, the percentage allocated to each candidate may be based on their relative candidate scores. In an alternative embodiment, a predetermined first amount or percentage is recommended as the allocation for the most compatible candidate, a second amount or percentage for the second most compatible candidate, etc. (these amounts or percentages may be recommended regardless of the actual value of the compatibility scores or the difference in scores among candidates). It will be appreciated that, in other embodiments, other criteria may be used for determining the recommended contribution allocation among the top candidates. The screen may further include a column of scores associated with each of the candidates based on the analysis performed by the contribution allocation system.

Although not shown in FIG. 3, the graphical user interface through which the recommended contribution allocation is displayed may further include numerous options, such as, for example, expandable boxes, drop-down menus, or links through which contributors can view or be directed to more specific information regarding, for example, their compatibility with candidates on particular issues, breakdowns of how the candidate scores or recommended allocations were calculated, or more information regarding the candidates generally.

At stage 207, the contributor further has the option to make adjustments to the recommended contribution allocation to change it a contributor-adjusted allocation. For example, the contributor can select one or more candidates and compare them side-by-side so that the contributor may evaluate where each candidate stands regarding one or more issues or in comparison to one or more other criteria, and then adjust the allocation amounts as to each of those candidates accordingly. The contributor can further manually add or remove candidates from the contributor-adjusted allocation. In another example, the contributor can filter or customize the results so as to display an allocation among candidates for a selected issue considered in isolation (e.g., taking the candidates from the recommended contribution allocation and recalculating their relative allocation amounts based on a single issue). Other embodiments may allow filtering and sorting of the candidates of the recommended contribution allocation using other parameters such as geography, party affiliation, funds raised, etc., which may be helpful to a contributor engaged in adjustment of the initially recommended contribution allocations.

The system may further provided district-by-district, state-by-state, or other voting denomination maps for display to the contributor. Each voting denomination may include a visual indicator such as color coding to alert the contributor to relative desirability of the opportunity to invest by locality. The map may display an overall match and/or may allow the contributor to select one or more issues for ranking and comparison display. Each issue may be considered a layer, where the system may recalculate and display relative compatibility as layers are turned on and off. In one embodiment, candidate information is displayed on the map, such as the candidate score, the candidate's closest opponent's score, whether the candidate is an incumbent, his relative seniority, and his opponent's relative seniority. The scores may reflect overall compatibility values or, alternatively, may be filtered to provide an assessment of compatibility with respect to one or more selected issues. It may also display additional information about the candidates and/or their races, such as the spread, described in the figure as a polling average factor.

In one example, the map may show the contributor that hypothetical candidate A is a 90% match and hypothetical candidate B is an 85% match. Although candidate A is technically a better fit for the contributor and should be the preferred recipient of the contributor's funds, candidate B may have a nearly identical response as the contributor regarding a certain issue, e.g., gun rights, whereas candidate A may be less closely aligned. Even if the contributor indicates that gun rights are an important issue, that designation may not be controlling if the contributor also designates several other issues as important or provides rankings regarding a large number of issues—hence candidate A having a higher match percentage. In this example, the contributor may compare the two candidates, for example, by filtering for their positions on gun rights, and after determining that the match between them is acceptably close, determine that candidate B's response to a certain issue or issues overrides the rankings, and elect to donate to candidate B.

At stage 209, the contribution allocation system facilitates the donation of the contributor's capital according to the recommended contribution allocation or the contributor-adjusted contribution allocation. In one embodiment, the system includes tools to connect the contributor to one or more ways of contributing to the candidate, including the display of the candidate's mailing address or a link to a payment system designated by the candidate such as PayPal. Further, the system may provide additional information on the candidates including videos, commercials, links to other websites, etc., to allow the contributor to learn more about the recommended candidates and/or to help the contributor make further adjustments or customizations of the amount he or she wishes to contribute to candidates. In one embodiment, the contribution allocation system may include a payment interface where a contributor can make donations to multiple candidates according to his or her recommended contribution allocation or contributor-adjusted contribution allocation at the same time.

To illustrate the principles of the present invention in one exemplary embodiment, a simplified example is provided as follows. First, a contributor accesses the contribution allocation system through a web browser on a computer and registers with the system. The contributor then provides responses to a series of prompts regarding his positions on various issues. In this example, the contributor indicates that he is a strong supporter of gun rights (so much so that he indicates gun rights as a disqualifier issue) and mildly opposed to an ongoing armed conflict. Further, in this illustrative example, there are only four candidates:
Candidate A, who wants to implement strict gun control and opposes the ongoing armed conflict;
Candidate B, who is a strong supporter of gun rights and supports the ongoing armed conflict;
Candidate C, who is a strong supporter of gun rights and opposes the ongoing armed conflict; and
Candidate D, who is a strong supporter of gun rights and opposes the ongoing armed conflict.
   The system then compares the contributor's positions on each of the two issues (gun rights and the ongoing armed conflict) to the candidates' positions and determines, for example, that Candidate A is disqualified and assigns Candidate A a score of zero (or simply removes Candidate A from consideration). Candidates B, C, and D receive base scores of 40, 60, and 60, respectively (for example, this base score could be calculated starting from a baseline score of 0 and then giving candidates B, C, and D) all 50 points for agreeing with the contributor on an important issue to the contributor—gun control—with candidate B losing 10 points for disagreeing with the contributor on a less important issue to the contributor—the ongoing armed conflict—while candidates C and D gain 10 points for agreeing with the contributor on the less important issue).

Moreover, in this example, assume that Candidate B is not an incumbent candidate, is in a hotly contested contest with an opponent that strongly disagrees with Candidate B on gun rights, and is seeking a Senate seat where, under the current circumstances, the Senate is evenly divided on the issue of gun rights. Candidate C is also seeking a Senate seat but is an incumbent with a large lead in the polls and adequate campaign funding and is running against an opponent that also supports gun rights. Candidate D is an incumbent in the House of Representatives, which is generally already in favor of gun rights, but Candidate D trails in the polls and is known to have inadequate campaign funding. Using quantitative values assigned to these election-related parameters associated with each candidate, the contribution allocation system assigns a modifier of 2.5 to candidate B, 0.1 to candidate C, and 0.8 to candidate D. Thus, the system arrives at a final candidate score of 100 for candidate B, 6 for candidate C, and 48 for candidate D (base score multiplied by the modifier). Although candidate B was not the best match for the contributor in terms of agreement on issues, candidate B is determined to have the highest candidate score due to the election-related parameters (i.e., the contributor is most likely to advance the policy goals important to the contributor through a contribution to candidate B given the circumstances).

Further, in this example, the system further has a threshold score of 20 for being included in a recommended contribution allocation, and thus both Candidates A and C are excluded from the recommended contribution allocation. Further, because the election is still several months away, the system determines that the contributor would benefit from holding a sizeable cash reserve—e.g., 30%—and contributing the cash reserve at a later time when further developments are known. Thus, based on the scores of 100 and 48 given to the two eligible candidates and the 30% cash reserve, the system provides the contributor with a recommended contribution allocation of 47% to Candidate B, 23% to Candidate D, and 30% to be held as a cash reserve. The contributor then uses the contribution allocation system to perform some further research on Candidates B and D, and decides to customize that recommended allocation and adjust it to 60% to Candidate B, 20% to Candidate D, with 20% to be held as cash reserve. Then, the contributor uses the contribution allocation system to make a donation in accordance with his adjusted contribution.

The foregoing example is provided for illustrative purposes only and does not encompass all of the different issues and election-related parameters that are contemplated by the present invention for use in the matching and analysis processes, nor does it encompass the numerous variations of embodiments of the present invention contemplated herein. Further, it will be appreciated that, based on the teachings provided herein, one skilled in the art would be able to implement various different algorithms for assessing compatibility and accounting for election-related parameters—for example, by using statistical modeling and multivariable processing techniques.

It will be appreciated that candidates' and contributors' political positions may change over time, as well as the landscape of the election generally. In an embodiment, the contribution allocation system continually or periodically imports external data—e.g., polling results to gauge how close the race is, or polling data regarding the makeup of the political body for which the candidate is running in order to estimate how large of a majority or how small of a minority the candidate's party is likely to possess post-election, or candidate financials and policy statements, etc.—and updates the information stored in its database(s) so as to remain up-to-date. Similarly, the contributors and candidates may update the information in their profiles stored in the system and change update their responses to various prompts. Based on the updating of information at the contribution allocation system, the contribution allocation system may provide updated candidate stores and an updated recommended contribution allocation. For example, a contributor could refer to the updated recommended contribution allocation in deciding how to use his or her cash reserve remaining from a previous set of donations.

In addition to providing contributors with information regarding candidates and matching candidates to potential contributors, the contribution allocation system may further provide candidates with access to a user-base of political contributors to solicit votes and/or contributions. For example, the contribution allocation system may include a messaging system (such as an e-mail inbox hosted by the system, or social network messaging system, or internet forum), that allows candidates to communicate directly with potential contributors. In order to prevent contributors from being flooded with solicitations from candidates with whom they have only marginal compatibility, in one embodiment the system may require a predetermined compatibility threshold be met before granting access to those contributors.

The system and its messaging system may further allow candidates to maximize efficiency by soliciting only those contributors that are likely to contribute and/or vote—for example based on publicly available voting records and/or a contributor's past history of making contributions. Contributors may also benefit by confining such political solicitation communications to a single forum—i.e., the contribution allocation system—which eliminates or mitigates the need for receiving such communication from their mail or personal e-mail accounts.

In one embodiment, this access to potential contributors is provided to candidates for free so long as the candidates register for the contribution allocation system. In another embodiment, the system may require that candidates provide some form of funds or compensation to receive contributor information and/or to communicate with them, with a larger amount of funds being required to receive information about or communicate with more compatible contributors.

In further embodiments of the contribution allocation system, the system may perform compatibility analysis between one contributor and other contributors, for example, using a similar method of analysis as discussed above in determining compatibility between contributors and candidates. Contributors would be able to use this matching functionality to contact one another to form communities or groups of like-minded individuals. Similarly, based on a contributor's responses, the system may suggest one or more pre-existing groups, on-site or off-site, for the contributor to join. A group may include those having overall compatibility scores within a predetermined threshold or, alternatively, may be defined on an issues-by-issue basis. Alternatively, communities may contain individuals that have similar contribution behaviors such as contributing to the same candidate or same party.

It will thus be appreciated that the described system and method allow contributors to benefit from deep analysis they cannot perform themselves, awareness of legislative contests that can most benefit from their contributions, easy-to-understand recommendations for financial resource allocations, and the satisfaction of knowing that their contributions are not wasted, but rather being optimized for the purpose of advancing their policy goals. Further, candidates benefit from more efficient identification of potential contributors and more efficient communication with them. Better use of campaign contributions increases the likelihood of victory.

It will be appreciated that the foregoing methods and implementations are merely examples of the inventive principles, and that these illustrate only preferred techniques. Other embodiments of the invention may differ in detail from foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for providing efficient contribution allocation recommendations to contributors providing contributions to political candidates, the method comprising:
receiving, by a contribution allocation system, inputs from a contributor indicating the contributor's position with respect to a plurality of issues;
quantitatively comparing the contributor's positions with respect to the plurality of issues to a plurality of candidates' positions with respect to the plurality of issues;
assigning a score to each of a plurality of candidates based on their compatibility with respect to the compared issues and further based on election-related parameters; and
providing a recommended contribution allocation for the contributor based on the scores assigned to the plurality of candidates.

2. The method of claim 1, wherein the inputs received from the contributor include designation of an issue as a disqualifier issue, and wherein candidates having a position that conflicts with the contributor's position regarding the disqualifier issue are not included in the recommended contribution allocation for the contributor.

3. The method of claim 1, wherein the election-related parameters include one or more parameters quantitatively representing at least one of:
the contributor's compatibility with a candidate's opponent;
a candidate's likelihood of success;
composition of a political body to which a candidate is seeking election;
an estimated margin of victory;
the quantity of elections determined by the system to be within a predetermined threshold margin;
status of a candidate within a political body;
status of a candidate's competitor within a political body; or
a degree of saturation associated with an election.

4. The method of claim 1, further comprising:
providing the contributor with an interface for sending financial resources to one or more candidates.

5. The method of claim 1, further comprising:
receiving input from the contributor that adjusts the recommended contribution allocation to a contributor-adjusted contribution allocation.

6. The method of claim 1, wherein assigning a score to each of the plurality of candidates further comprises:
determining a base score for each candidate;
determining a gamma value for each election corresponding to the candidates based on the election-related parameters; and
adjusting the base score based on the determined gamma value.

7. The method of claim 6, wherein the election-related parameters used in determining the gamma value include at least one of: whether a candidate is an incumbent, status of a candidate within a political body; status of a candidate's fundraising; or expected costs for a candidate's campaign.

8. The method of claim 1, further comprising:
receiving a limit on the number of candidates included in the recommended contribution allocation, wherein the limit is designated by the contributor.

9. The method of claim 1, wherein the recommended contribution allocation includes a predetermined number of candidates.

10. The method of claim 1, wherein the recommended contribution allocation includes an allocation for a cash reserve.

11. A non-transitory computer-readable medium, part of a contribution allocation system, having computer-executable instructions for providing efficient contribution allocation recommendations to contributors providing contributions to political candidates stored thereon, the computer-executable instructions comprising instructions for:
receiving inputs from a contributor indicating the contributor's position with respect to a plurality of issues;
quantitatively comparing the contributor's positions with respect to the plurality of issues to a plurality of candidates' positions with respect to the plurality of issues;
assigning a score to each of a plurality of candidates based on their compatibility with respect to the compared issues and further based on election-related parameters; and
providing a recommended contribution allocation for the contributor based on the scores assigned to the plurality of candidates.

12. The non-transitory computer-readable medium of claim 11, wherein the inputs received from the contributor include designation of an issue as a disqualifier issue, and wherein candidates having a position that conflicts with the contributor's position regarding the disqualifier issue are not included in the recommended contribution allocation for the contributor.

13. The non-transitory computer-readable medium of claim 11, wherein the election-related parameters include one or more parameters quantitatively representing at least one of:
the contributor's compatibility with a candidate's opponent;
a candidate's likelihood of success;
composition of a political body to which a candidate is seeking election;
an estimated margin of victory;
the quantity of elections determined by the system to be within a predetermined threshold margin;
status of a candidate within a political body;
status of a candidate's competitor within a political body; or
a degree of saturation associated with an election.

14. The non-transitory computer-readable medium of claim 11, wherein the computer-executable instructions further comprise instructions for:
providing the contributor with an interface for sending financial resources to one or more candidates.

15. The non-transitory computer-readable medium of claim 11, wherein the computer-executable instructions further comprise instructions for:
receiving input from the contributor that adjusts the recommended contribution allocation to a contributor-adjusted contribution allocation.

16. The non-transitory computer-readable medium of claim 11, wherein assigning a score to each of the plurality of candidates further comprises:
determining a base score for each candidate;
determining a gamma value for each election corresponding to the candidates based on the election-related parameters; and
adjusting the base score based on the determined gamma value.

17. The non-transitory computer-readable medium of claim 16, wherein the election-related parameters used in determining the gamma value include at least one of: whether a candidate is an incumbent, status of a candidate within a political body; status of a candidate's fundraising; or expected costs for a candidate's campaign.

18. The non-transitory computer-readable medium of claim 11, wherein the computer-executable instructions further comprise instructions for:
receiving a limit on the number of candidates included in the recommended contribution allocation, wherein the limit is designated by the contributor.

19. The non-transitory computer-readable medium of claim 11, wherein the recommended contribution allocation includes a predetermined number of candidates.

20. The non-transitory computer-readable medium of claim 11, wherein the recommended contribution allocation includes an allocation for a cash reserve.
